(19) United States
(12) Patent Application Publication
(10) Pub. No.: US 2025/0048511 A1
(43) Pub. Date: Feb. 6, 2025

(54) ANTENNA FIXING SYSTEM

(71) Applicant: WHIRLPOOL CORPORATION, BENTON HARBOR, MI (US)

(72) Inventors: Junhua Wu, Guangdong (CN); Xishuo Qiu, Guangdong (CN); Xin Li, Guangdong (CN)

(73) Assignee: WHIRLPOOL CORPORATION, BENTON HARBOR, MI (US)

(21) Appl. No.: 18/718,942

(22) PCT Filed: Dec. 17, 2021
(86) PCT No.: PCT/CN2021/139106

§ 371 Date: Jun. 12, 2024

(51) Int. Cl. H05B 6/72

(52) U.S. Cl. CPC H05B 6/72

(57) ABSTRACT

An antenna fixing system for use in a microwave oven. The antenna fixing system includes a stirring piece, a ceramic support, and other components that couple an antenna to a stirrer motor while limiting unintentional movement of the antenna in multiple planes.

### CROSS-REFERENCE TO FOREIGN PRIORITY APPLICATION

The present application claims the benefit under 35 U.S.C. § 119(b), 119(e), 120, 121, 365(c), and/or 386(c) of PCT/CN2021/139106 filed Dec. 17, 2021.

### BACKGROUND OF THE DISCLOSURE

The present disclosure generally relates to an antenna fixing assembly for a microwave oven.

Microwave ovens have a cooking cavity that receives a source of microwave energy. Waveguides are used to help direct the microwave energy from the source of the microwave energy to the cooking cavity. Reflective mode stirrers can also be used to help distribute the microwave energy to the cooking cavity. A reflective stirrer antenna is placed in the path of the incoming microwave energy and the antenna is rotated by a stirrer motor. The microwave energy is deflected by the openings and other surfaces of the antenna and distributed within the cooking cavity. The antenna is typically positioned near the bottom plate of the cooking cavity and/or the heating plate. The antenna is typically positioned to move when the stirrer motor rotates. The antenna typically has the ability to move in different planes, including in an X, Y, and/or Z plane due to gaps and/or lack of support between the stirrer motor and the antenna. When the microwave oven is moved during shipping, installation, etc., the antenna can scratch surfaces of the cooking cavity and/or surfaces on the electric wire of the heating plate. In addition, the antenna can make noise when the stirrer motor rotates the antenna during cooking. Thus, an antenna fixing system that prevents or reduces the ability of the antenna to move in different planes would reduce the potential damage to components of the microwave oven and noise during operation.

### SUMMARY OF THE DISCLOSURE

One aspect of the present invention is a microwave oven with an antenna fixing system. The microwave oven has a cooking cavity with an antenna located adjacent to the cooking cavity. The antenna fixing system includes a stirrer motor having a rotating projection. A stirrer piece includes a section that surrounds the rotating projection of the stirrer motor as well as an upward projection with an opening. A spring member is coupled to the stirrer piece by having an extension that is received within the opening of the stirrer piece. The antenna fixing system includes a bearing base with an aperture. The antenna fixing system also includes a ceramic support member having a first end section with a first diameter, a second end section with a second diameter, and a medial section with a third diameter that is larger than the first diameter and the second diameter, thus forming a shoulder on the ceramic support member. The antenna fixing system includes an antenna support member that is at least partly received in the aperture of the bearing base. The antenna support member has an internal aperture that surrounds at least a portion of the first end section of the ceramic support. The antenna support member has a surface that contacts at least a portion of the surface of the antenna and another surface that contacts the shoulder of the ceramic support member. A portion of the spring member is received in an opening in the ceramic support member.

Another aspect of the present invention is an antenna fixing system for a microwave oven. The antenna fixing system includes an antenna and a stirrer motor having a rotating projection. A stirrer piece is coupled to the stirrer motor and includes an upward projection and an opening. A spring member is coupled to the stirrer piece and to a ceramic support member. The ceramic support member has a first end section with a first diameter, a second end section with a second diameter, and a medial section with a third diameter that is larger than the first diameter and the second diameter thereby forming a shoulder on the ceramic support member. The antenna fixing assembly includes a bearing base having an aperture that surrounds a portion of an antenna support member. The antenna support member has an internal aperture that surrounds at least a portion of the first end section of the ceramic support and also has a surface that contact the antenna and another surface that contacts the shoulder on the ceramic support member. A portion of the spring member is also received in an opening in the ceramic support member.

Yet another aspect of the present invention is an antenna assembly for a microwave oven. The antenna assembly includes an antenna with a plurality of openings. The antenna assembly also includes a stirrer motor having a rotating projection and a stirrer piece that is coupled to the rotating projection. A spring member includes an extension that is received in an opening on the stirrer piece. The antenna assembly includes a bearing base having an aperture that receives an antenna support member. The antenna assembly includes a ceramic support member having a first end section with a first diameter, a second end section with a second diameter, and a medial section with a third diameter that is larger than the first diameter and second diameter thereby forming a shoulder on the ceramic support member. The antenna support member has an internal aperture that surrounds at least a portion of the first end section of the ceramic support member. The antenna support member has a surface that contacts at least a portion of one surface of the antenna and another surface that contacts the shoulder on the ceramic support member. The spring member is also coupled to an opening in the ceramic support member. The antenna assembly also includes a spring cover that surrounds a portion of the spring member and an opening that is received around the second end section of the ceramic support member.

These and other features, advantages, and objects of the present disclosure will be further understood and appreciated by those skilled in the art by reference to the following specification, claims, and appended drawings.

### BRIEF DESCRIPTION OF THE DRAWINGS

In the drawings:

FIG. 1 is a rear elevational cross-sectional view of a microwave oven including an antenna fixing assembly;

FIG. 2 is a rear cross-sectional view of the antenna fixing assembly shown in FIG. 1 taken in section II;

FIG. 3 is a front perspective view of the components of the antenna fixing assembly shown in FIG. 1;

FIG. 4 is a front perspective cross-sectional view of the components of the antenna fixing assembly shown in FIG. 3;

FIG. 5 is a front perspective view of the microwave oven shown in FIG. 1;

FIG. 6 is a top perspective view of the antenna fixing assembly;

FIG. 7 is a bottom perspective view of the antenna fixing assembly;

FIG. 8 is a front perspective cross-sectional view of the antenna fixing assembly;

FIG. 9 is a front perspective view of the antenna fixing assembly coupled with the waveguide housing of the microwave oven;

FIG. 10 is a bottom perspective view of the antenna fixing assembly as illustrated in FIG. 9;

FIG. 11 is a top elevational view of the antenna fixing assembly shown in FIG. 9;

FIG. 12 is a front elevational view of the components of the antenna fixing assembly shown in FIG. 9;

FIG. 13 is a front perspective view of the components of the antenna fixing assembly shown in FIG. 9;

FIG. 14 is a front perspective cross-sectional view of the components of the antenna fixing assembly shown in FIG. 9;

FIG. 15 is a bottom perspective view of the components of the antenna fixing assembly shown in FIG. 9; and

FIG. 16 is a bottom cross-sectional view of the components of the antenna fixing assembly shown in FIG. 9.

The components in the figures are not necessarily to scale, emphasis instead being placed upon illustrating the principles described herein.

### DETAILED DESCRIPTION

The present illustrated embodiments reside primarily in combinations of method steps and apparatus components related to a bottom vent assembly for an oven. Accordingly, the apparatus components and method steps have been represented, where appropriate, by conventional symbols in the drawings, showing only those specific details that are pertinent to understanding the embodiments of the present disclosure so as not to obscure the disclosure with details that will be readily apparent to those of ordinary skill in the art having the benefit of the description herein. Further, like numerals in the description and drawings represent like elements.

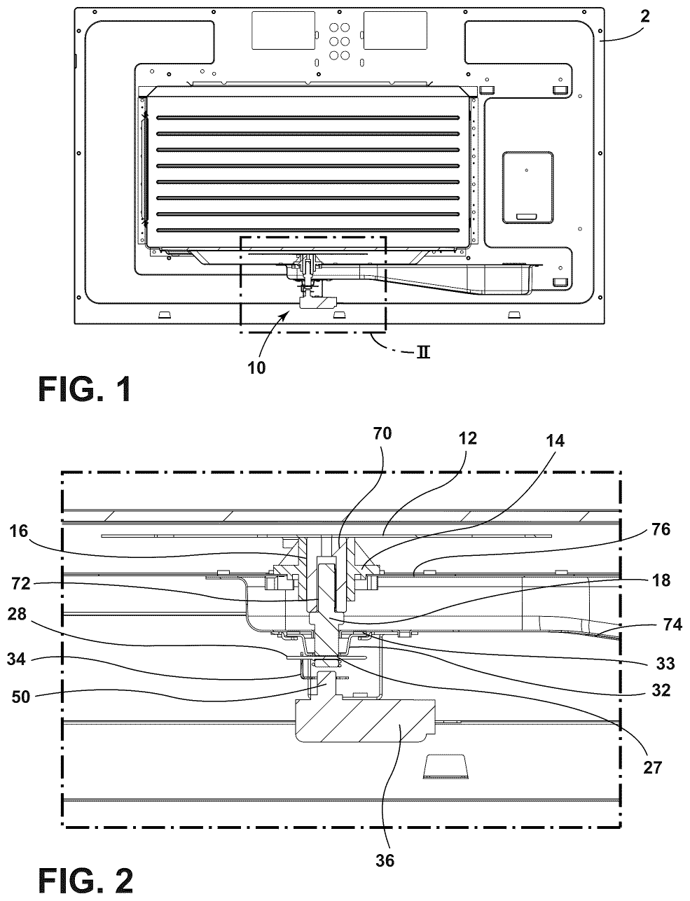

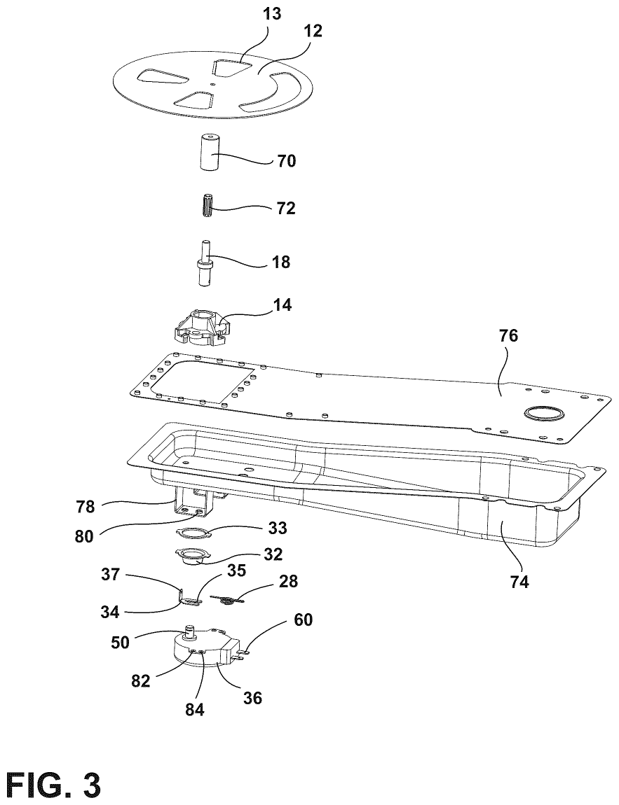

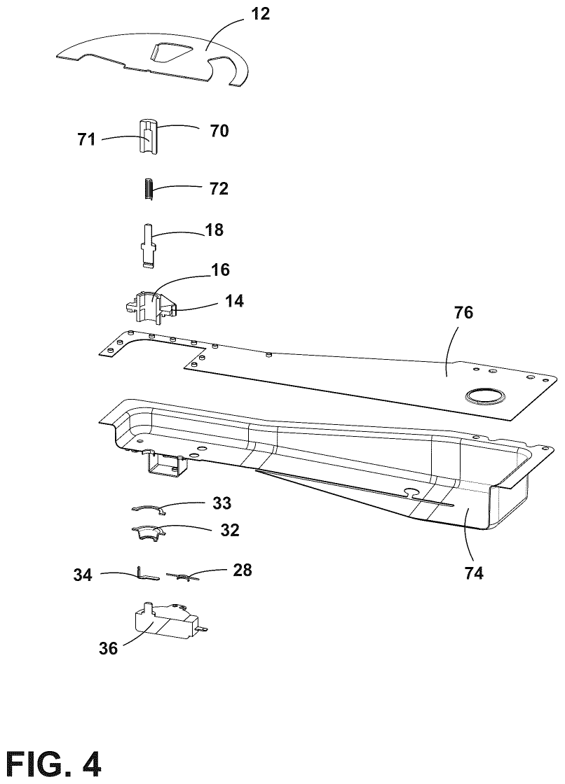

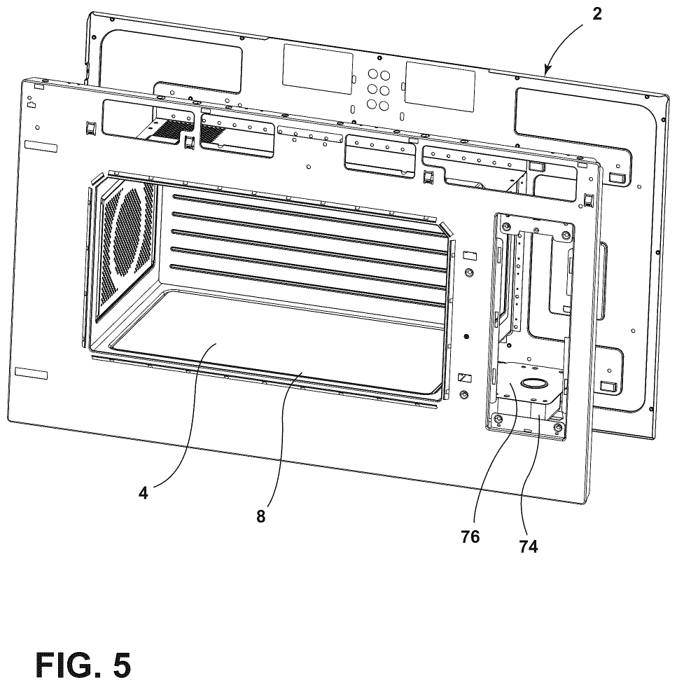

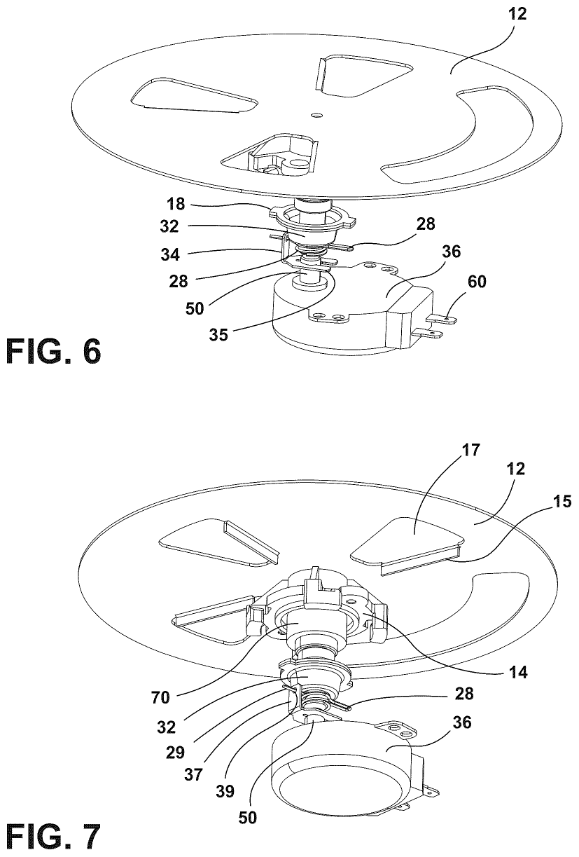

For purposes of description herein, the terms “upper,” “lower,” “right,” “left,” “rear,” “front,” “vertical,” “horizontal,” and derivatives thereof shall relate to the disclosure as oriented in FIG. 1. Unless stated otherwise, the term “front” shall refer to the surface of the element closer to an intended viewer, and the term “rear” shall refer to the surface of the element further from the intended viewer. However, it is to be understood that the disclosure may assume various alternative orientations, except where expressly specified to the contrary. It is also to be understood that the specific devices and processes illustrated in the attached drawings, and described in the following specification are simply exemplary embodiments of the inventive concepts defined in the appended claims. Hence, specific dimensions and other physical characteristics relating to the embodiments disclosed herein are not to be considered as limiting, unless the claims expressly state otherwise.

The terms “including,” “comprises,” “comprising,” or any other variation thereof, are intended to cover a non-exclusive inclusion, such that a process, method, article, or apparatus that comprises a list of elements does not include only those elements but may include other elements not expressly listed or inherent to such process, method, article, or apparatus. An element proceeded by “comprises a . . . ” does not, without more constraints, preclude the existence of additional identical elements in the process, method, article, or apparatus that comprises the element.

By way of overview, the present invention is generally directed to a microwave oven 2 that has an antenna fixing assembly 10. The microwave oven 2 has a cooking cavity 4 with a door. Typically a heating plate 8 is included within the cooking cavity 4 of microwave oven 2. The microwave oven 2 has a waveguide that directs microwave energy from the magnetron or other source to the cooking cavity 4. The waveguide includes waveguide housing 74 and waveguide cover 76.

In the illustrated embodiment, the antenna fixing assembly 10 is positioned below the cooking cavity 4 of microwave oven 2. The antenna fixing assembly 10 includes an antenna 12 which is positioned adjacent to the cooking cavity 4. The antenna 12 can have one or more openings 13 and can include projecting edges 15 adjacent to the openings 13 in antenna 12. The antenna 12 can include a centrally located opening 77. The antenna 12 can be made from any suitable material that can reflect and/or direct the microwave energy. In the illustrated embodiment, the antenna 12 is metal.

The antenna fixing assembly 10 includes a stirrer motor 36. The stirrer motor 36 includes a rotating projection 50 and mounting flanges 82 with openings 84. The stirrer motor 36 also includes an electrical connection 60 that can be coupled to a power source to power the stirrer motor 36 to rotate the rotating projection 50.

A stirring piece 34 is coupled to the rotating projection 50 of stirrer motor 36. The stirring piece 34 includes an opening 35 that surrounds the rotating projection 50 of stirrer motor 36. The stirring piece 34 also includes an upward projection 37 which includes opening 39. The rotation of the rotating projection 50 will cause the stirring piece 34 to rotate given the coupling of the opening 35 of stirring piece 34 around the rotating projection 50 of the stirrer motor 36. The stirring piece 34 can be made from any high strength material. In the illustrated embodiment, the stirring piece 34 is made from metal.

A spring member 28 includes a projection 29 that is received within opening 39 of the stirring piece 34. The spring member 28 also includes a portion that is received within the middle of a ceramic support member 18. Thus, when the stirring piece 34 rotates, the spring member 28 will also rotate thereby rotating the ceramic support member 18. The spring member 28 can be made from any suitable resilient material, including, but not limited to, metal.

The antenna fixing assembly 10 also includes a spring cover 32 that surrounds at least a portion of spring member 28. The spring cover 32 is coupled adjacent to the bottom surface of the waveguide housing 74. A spring cover sponge 33 can be positioned in between the spring cover 32 and the bottom surface of the waveguide housing 74 as illustrated in FIG. 2.

The waveguide housing 74 includes stirrer motor bracket 78 with openings 80 that align with the openings 84 in the mounting flange 82 of the stirrer motor 36. Fasteners can be used to couple the stirrer motor 36 to the stirrer motor bracket 78 on waveguide housing 74. The waveguide housing 74 is covered by waveguide cover 76.

The antenna fixing assembly 10 also includes a bearing base 14 with opening 16. The bearing base 14 is coupled to the top surface of the waveguide cover 76, as illustrated in FIG. 2. The bearing base 14 can be coupled to the waveguide cover 76 using fasteners or other coupling methods. The bearing base 14 can be made from a polymeric or metal material.

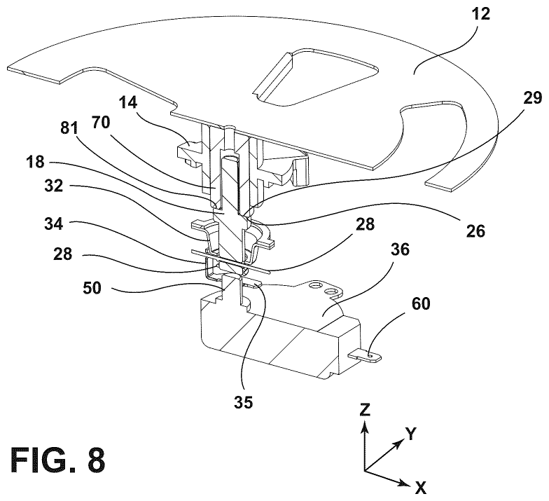

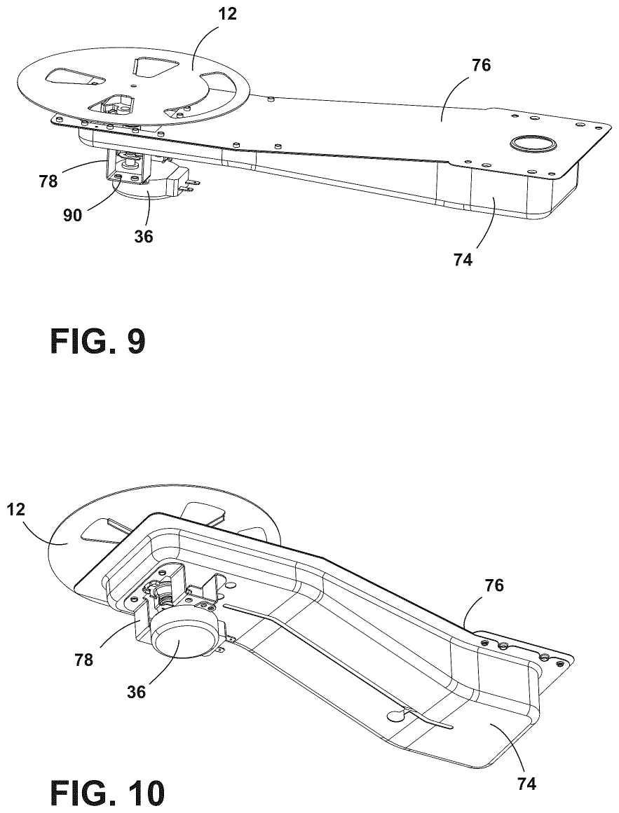

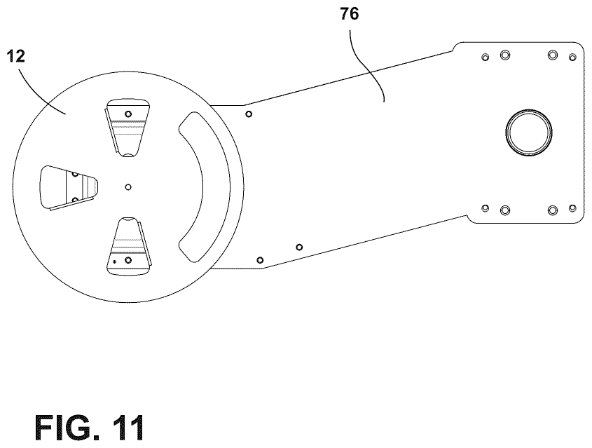

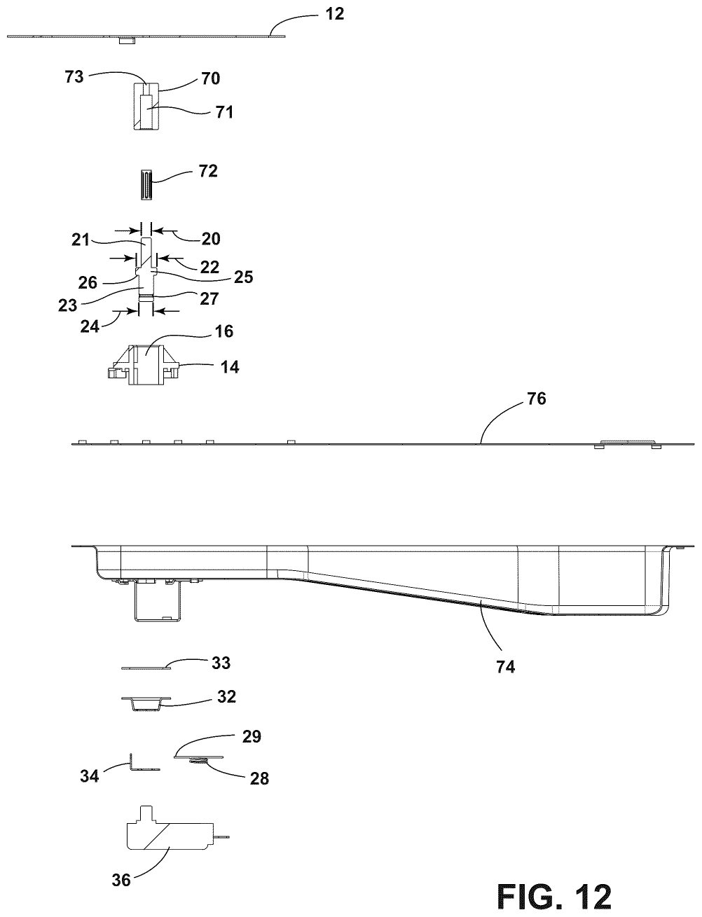

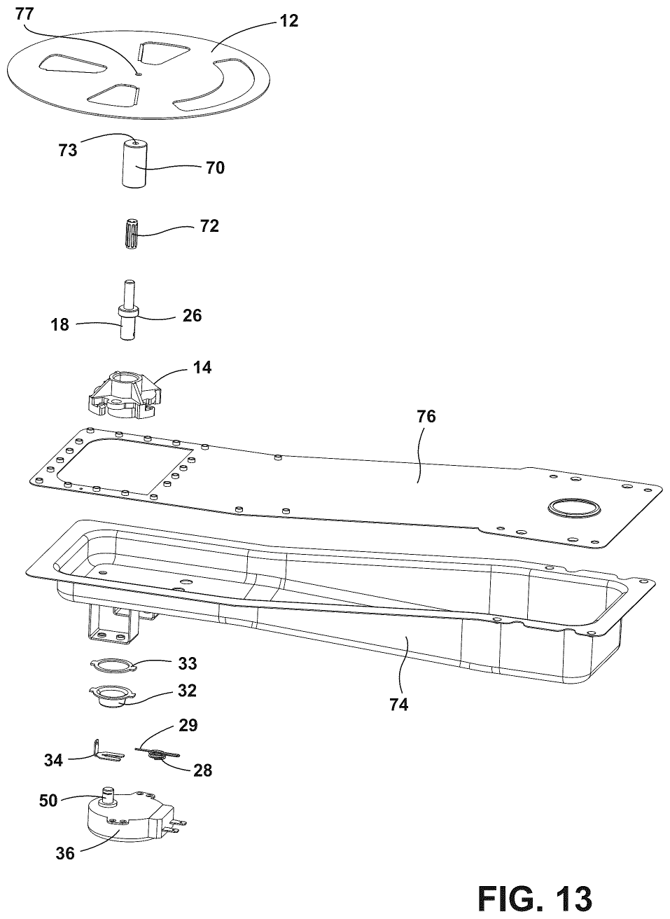

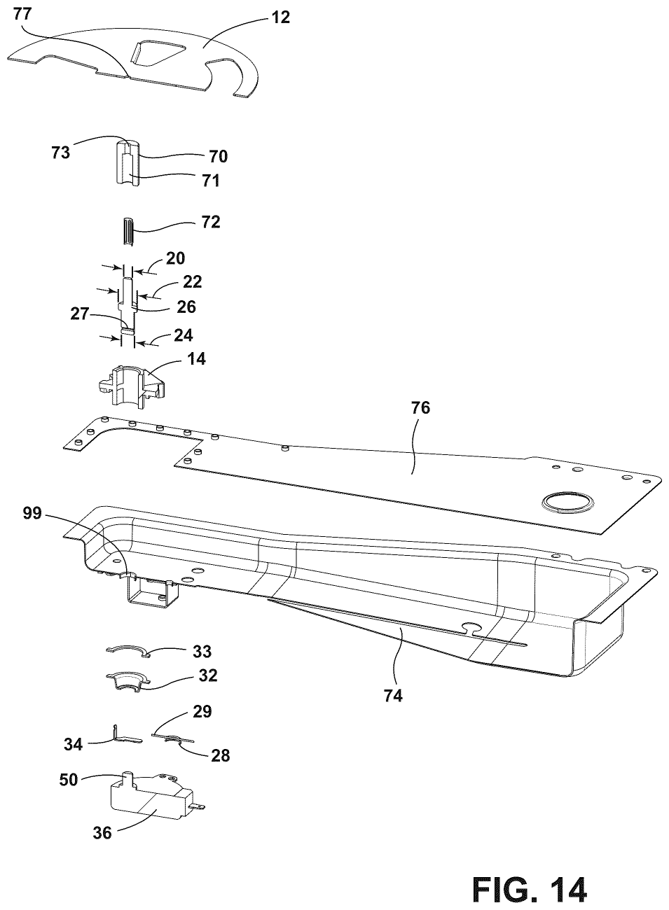

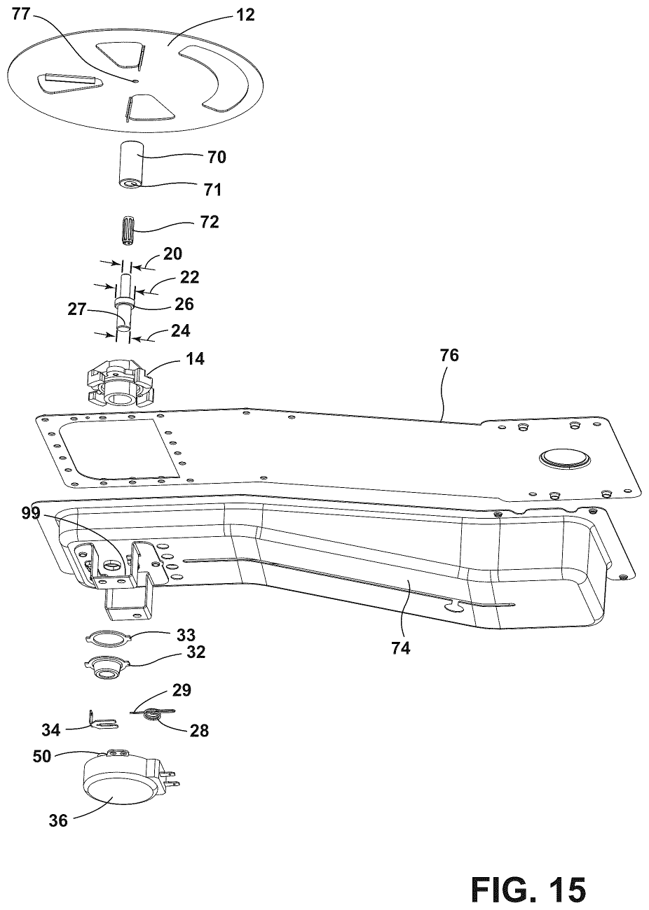

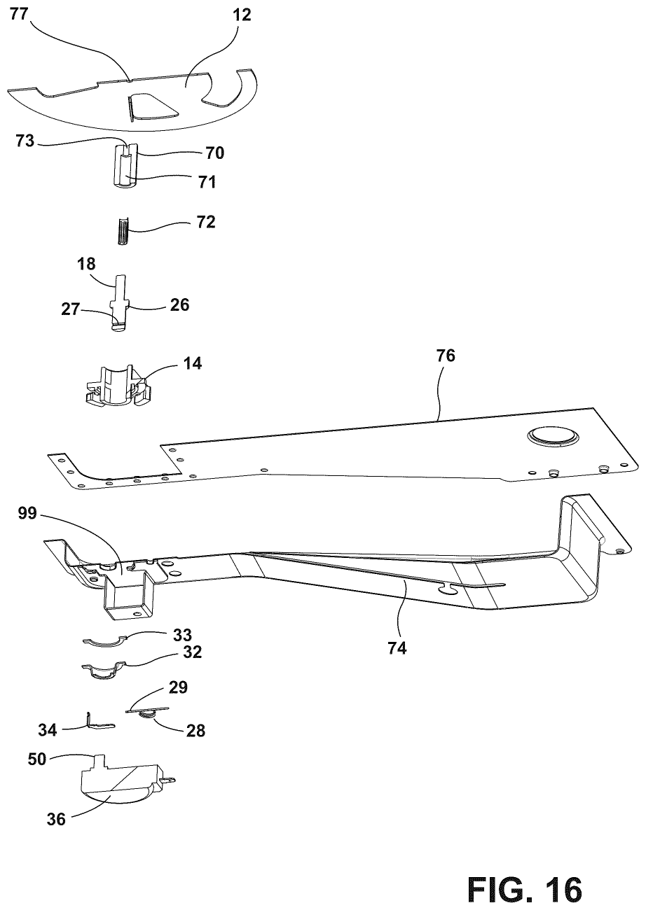

The ceramic support member 18 includes a first diameter 20 on first end section 21, a second diameter 24 on second end section 23, and a third diameter 22 in medial section 25, as illustrated in FIG. 12. The third diameter 22 is larger than the first diameter 20 and the second diameter 24, thereby creating a shoulder 26 on the ceramic support member 18. The second end section 23 includes an opening 27 which receives a portion of the spring member 28, as illustrated in FIGS. 2 and 8.

At least a portion of the second end section 23 of the ceramic support member 18 is surrounded by the spring cover 32, as illustrated in FIG. 8. The top surface 29 of the shoulder 26 contacts the bottom surface 81 of the antenna support member 70.

The antenna support member 70 includes an aperture 71 and an opening 73, as illustrated in FIG. 12. A spring sheet 72 can be positioned around the first end section 21 of the ceramic support member 18 before it is received within the aperture 71 of the antenna support member 70. The spring sheet 72 can be made from a polymeric or metal material and can include grooved, raised, and/or textured surfaces to help couple the antenna support member 70, the spring sheet 72, and the ceramic support member 18 together. The opening 73 of antenna support member 70 aligns with the opening 77 in the antenna 12 and can be coupled by used of a fastener or other means. Thus, when the stirrer motor 36 is actuated, the rotation of the rotating projection 50 will translate movement to the antenna 12 by moving stirring piece 34 and the connected spring member 28 which thereby rotates the ceramic support member 18 and the antenna support member 70.

As can be seen in FIG. 8, the positioning and the coupling of the components of the antenna fixing assembly 10 restricts and/or prevents movement of the antenna 12 in different planes, such as the illustrated X, Y, and Z planes. The antenna 12 should, therefore, not contact the heating plate or bottom plate 8 of the microwave oven 2 when the microwave oven 2 is moved during shipping, installation, etc. In addition, since the rotational movement of the stirrer motor 36 is translated to the antenna 12 while the antenna 12 is supported in the X, Y, and Z directions, noise will be reduced during operation of the stirrer motor 36.

It will be understood by one having ordinary skill in the art that construction of the described disclosure and other components is not limited to any specific material. Other exemplary embodiments of the disclosure disclosed herein may be formed from a wide variety of materials, unless described otherwise herein.

For purposes of this disclosure, the term “coupled” (in all of its forms, couple, coupling, coupled, etc.) generally means the joining of two components (electrical or mechanical) directly or indirectly to one another. Such joining may be stationary in nature or movable in nature. Such joining may be achieved with the two components (electrical or mechanical) and any additional intermediate members being integrally formed as a single unitary body with one another or with the two components. Such joining may be permanent in nature or may be removable or releasable in nature unless otherwise stated.

It is also important to note that the construction and arrangement of the elements of the disclosure as shown in the exemplary embodiments is illustrative only. Although only a few embodiments of the present innovations have been described in detail in this disclosure, those skilled in the art who review this disclosure will readily appreciate that many modifications are possible (e.g., variations in sizes, dimensions, structures, shapes and proportions of the various elements, values of parameters, mounting arrangements, use of materials, colors, orientations, etc.) without materially departing from the novel teachings and advantages of the subject matter recited. For example, elements shown as integrally formed may be constructed of multiple parts or elements shown as multiple parts may be integrally formed, the operation of the interfaces may be reversed or otherwise varied, the length or width of the structures and/or members or connector or other elements of the system may be varied, the nature or number of adjustment positions provided between the elements may be varied. It should be noted that the elements and/or assemblies of the system may be constructed from any of a wide variety of materials that provide sufficient strength or durability, in any of a wide variety of colors, textures, and combinations. Accordingly, all such modifications are intended to be included within the scope of the present innovations. Other substitutions, modifications, changes, and omissions may be made in the design, operating conditions, and arrangement of the desired and other exemplary embodiments without departing from the spirit of the present innovations.

It will be understood that any described processes or steps within described processes may be combined with other disclosed processes or steps to form structures within the scope of the present disclosure. The exemplary structures and processes disclosed herein are for illustrative purposes and are not to be construed as limiting.

What is claimed is:

1. A microwave oven with an antenna fixing system, comprising:
a microwave oven having a cooking cavity with an antenna located adjacent to said cooking cavity;
a stirrer motor having a rotating projection;
a stirrer piece that includes an upward projection, a section that surrounds said rotating projection of said stirrer motor, and an opening;
a spring member that includes a first extension that is received in said opening on said stirrer piece;
a bearing base having an aperture;
a ceramic support member having a first end section with a first diameter, a second end section with a second diameter, and a medial section with a third diameter that is larger than said first diameter and said second diameter forming a shoulder on said ceramic support member;
an antenna support member that includes at least a portion that is received within said aperture in said bearing base, having an internal aperture that surrounds at least a portion of said first end section of said ceramic support member, said antenna support member having a surface that contacts at least a portion of one surface of said antenna and another surface that contacts said shoulder on said ceramic support member; and
wherein a portion of said spring member is received in an opening in said ceramic support member.

2. The microwave oven of claim 1, including a spring cover that surrounds a portion of said spring member, said spring cover including an opening that is received around said second end section in said ceramic support member.

3. The microwave oven of claim 2, including a spring cover sponge that contacts a surface of said spring cover.

4. The microwave oven of claim 1, including a spring sheet that is located between the outer diameter of a portion of said first end section of said ceramic support member and the inner diameter of said internal aperture in said antenna support member.

5. The microwave oven of claim 3, including a waveguide housing with at least one bracket member for coupling to said stirrer motor.

6. The microwave oven of claim 5, wherein said waveguide housing includes a support opening that surrounds a portion of said second end section of said ceramic support member.

7. The microwave oven of claim 6, wherein said spring cover couples to the exterior lower surface of said waveguide housing adjacent to said support opening, with said spring cover sponge positioned between surfaces of said spring cover and said lower surface of said waveguide housing.

8. The microwave oven of claim 7, wherein said bearing base couples to the interior lower surface of said waveguide housing adjacent to said support opening.

9. An antenna fixing assembly for a microwave oven, comprising:
an antenna;
a stirrer motor having a rotating projection;
a stirrer piece that includes an upward projection, a section that surrounds said rotating projection of said stirrer motor, and an opening;
a spring member that includes a first extension that is received in said opening on said stirrer piece;
a bearing base having an aperture;
a ceramic support member having a first end section with a first diameter, a second end section with a second diameter, and a medial section with a third diameter that is larger than said first diameter and said second diameter forming a shoulder on said ceramic support member;
an antenna support member that includes at least a portion that is received within said aperture in said bearing base, having an internal aperture that surrounds at least a portion of said first end section of said ceramic support member, said antenna support member having a surface that contacts at least a portion of one surface of said antenna and another surface that contacts said shoulder on said ceramic support member; and
wherein a portion of said spring member is received in an opening in said ceramic support member.

10. The antenna fixing assembly claim 9, including a spring cover that surrounds a portion of said spring member, said spring cover including an opening that is received around said second end section in said ceramic support member.

11. The antenna fixing assembly of claim 10, including a spring cover sponge that contacts a surface of said spring cover.

12. The antenna fixing assembly of claim 9, including a spring sheet that is located between the outer diameter of a portion of said first end section of said ceramic support member and the inner diameter of said internal aperture in said antenna support member.

13. The antenna fixing assembly of claim 11, including a waveguide housing with at least one bracket member for coupling to said stirrer motor.

14. The antenna fixing assembly of claim 13, wherein said waveguide housing includes a support opening that surrounds a portion of said second end section of said ceramic support member.

15. The antenna fixing assembly of claim 14, wherein said spring cover couples to the exterior lower surface of said waveguide housing adjacent to said support opening, with said spring cover sponge positioned between surfaces of said spring cover and said lower surface of said waveguide housing.

16. The antenna fixing assembly of claim 15, wherein said bearing base couples to the interior lower surface of said waveguide housing adjacent to said support opening.

17. An antenna assembly for a microwave oven, comprising:
an antenna with a plurality of openings;
a stirrer motor having a rotating projection;
a stirrer piece that includes an upward projection, a section that surrounds said rotating projection of said stirrer motor, and an opening;
a spring member that includes a first extension that is received in said opening on said stirrer piece;
a bearing base having an aperture;
a ceramic support member having a first end section with a first diameter, a second end section with a second diameter, and a medial section with a third diameter that is larger than said first diameter and said second diameter forming a shoulder on said ceramic support member;
an antenna support member that includes at least a portion that is received within said aperture in said bearing base, having an internal aperture that surrounds at least a portion of said first end section of said ceramic support member, said antenna support member having a surface that contacts at least a portion of one surface of said antenna and another surface that contacts said shoulder on said ceramic support member;
wherein a portion of said spring member is received in an opening in said ceramic support member; and
a spring cover that surrounds a portion of said spring member, said spring cover including an opening that is received around said second end section in said ceramic support member.

18. The antenna assembly of claim 17, including a spring cover sponge that contacts a surface of said spring cover.

19. The antenna assembly of claim 17, including a spring sheet that is located between the outer diameter of a portion of said first end section of said ceramic support member and the inner diameter of said internal aperture in said antenna support member.

20. The antenna assembly of claim 19, including a waveguide housing with at least one bracket member for coupling to said stirrer motor, wherein said waveguide housing includes a support opening that surrounds a portion of said second end section of said ceramic support member.
